(19) United States
(12) Patent Application Publication
(10) Pub. No.: US 2026/0181626 A1
(43) Pub. Date: Jun. 25, 2026

(54) METHODS AND APPARATUS FOR SCHEDULING IN CELLULAR NETWORK

(71) Applicant: NTT DOCOMO, INC., Tokyo (JP)

(72) Inventors: David Alejandro Ramirez Dominguez, Sunnyvale, CA (US); Haralabos Papadopoulos, Sunnyvale, CA (US); Fujio Watanabe, Sunnyvale, CA (US)

(21) Appl. No.: 19/423,604

(22) Filed: Dec. 17, 2025

Related U.S. Application Data
(60) Provisional application No. 63/738,155, filed on Dec. 23, 2024.

(51) Int. Cl. H04W 72/1263; H04B 17/318

(52) U.S. Cl. CPC H04W 72/1263; H04B 17/328

(57) ABSTRACT

Embodiments provide systems and methods for scheduling a user equipment (UE) into resource blocks (RBs). The method may include initializing a base station (BS) with no scheduling bin assignment, identifying new bin settings for the BS, transmitting new bin settings to the BS, and collecting network data. Based on the measurement data such as reference signals received power of a BS (servRSRP) and RSRP of a neighbor BS (neigRSRP), UEs that are considered to cause more interference than information may be placed in a bin different from UEs that are considered to cause less to mid interference. The systems and methods provided herein may bring the expected and actual interference to be closer in magnitude, leading to better performance.

### RELATED APPLICATION

The present application claims the benefit of U.S. Provisional Patent Application No. 63/738,155, filed on Dec. 23, 2024, and entitled “METHODS AND APPARATUS FOR SCHEDULING IN CELLULAR NETWORK”, which is incorporated herein by reference in its entirety.

### FIELD OF DISCLOSURE

This disclosure relates generally to wireless technology and more particularly to techniques for scheduling a user equipment (UE) into resource blocks (RBs) in connection with physical uplink shared channel (PUSCH) power control.

### BACKGROUND

A telecommunication network is a system that allows for the exchange of information between entities, or nodes, through links. A cellular network is a type of a telecommunication network where the link to and from end nodes is wireless and the network is distributed over small geographical areas each cells, served by at least one fixed-location transceiver (such as a base station (BS)). BSs provide the cell with the network coverage which can be used for transmission of voice, data, and other types of content via radio waves. Each cell's coverage area is determined by factors such as the power of the transceiver, antenna parameters (antenna height, antenna beamwidth in horizontal and vertical direction, antenna azimuth direction and tilt, available MIMO configuration and capabilities, etc.), the terrain, and the frequency band being used. A user equipment (UE) communicates with the network or the cell through a BS. Interference between different UEs across different BSs may degrade overall system performance. For example, higher transmission power by a UE may be necessary for the UE to communicate with the BS but may cause more interference with other UEs.

### BRIEF SUMMARY

Processes, machines, and articles of manufacture for scheduling user equipments (UEs) into resource blocks (RBs) are described. In some embodiments, the method for scheduling a user equipment (UE) into resource blocks (RBs) includes: initializing a first base station (BS) with no scheduling bin assignment; identifying new bin settings for the first BS; transmitting new bin settings to the first BS; and collecting network data.

Other processes, machines, and articles of manufacture are also described hereby, which may be combined in any number of ways, such as with the embodiments of the brief summary, without departing from the scope of this disclosure.

### BRIEF DESCRIPTION OF THE DRAWINGS

The present disclosure is illustrated by way of example and not limitation in the figures of the accompanying drawings in which like references indicate similar elements. To easily identify the discussion of any particular element or act, the most significant digit or digits in a reference number refer to the figure number in which that element is first introduced.

FIG. 1 illustrates an example wireless communication system according to some embodiments.

FIG. 2 illustrates a BS or base station (BS) in communication with a user equipment (UE) device according to some embodiments.

FIG. 3 illustrates an example block diagram of a UE according to some embodiments.

FIG. 4 illustrates an example block diagram of a gNB or BS according to some embodiments.

FIG. 5 illustrates an example block diagram of cellular communication circuitry according to some embodiments.

FIG. 6 illustrates an example diagram of open radio access network (O-RAN) architecture according to some embodiments.

FIG. 7 illustrates example resource blocks (RBs) to shape interference according to some embodiments.

FIG. 8 illustrates an example diagram of UE's signals and interference according to some embodiments.

FIG. 9 schematically illustrates scheduling bins to shape interference according to some embodiments.

FIG. 10 schematically illustrates scheduling bins to shape interference according to some embodiments.

FIG. 11 illustrates an example of scheduling UEs into bins from a BS's perspective according to some embodiments.

FIG. 12 illustrates an example of scheduling UEs into bins from a BS's perspective according to some embodiments.

FIG. 13 illustrates an example of scheduling UEs into bins according to some embodiments.

FIGS. 14A-14D illustrate an example of scheduling UEs into bins, where the condition for scheduling UEs into upper bins is positive limits only (FIG. 14A), limits 0 to 10 (FIG. 14B), limits −5 to 10 (FIG. 14C), or where there is no binning (FIG. 14D), according to some embodiments.

FIGS. 15A-15D illustrates the relationship of the signal to interference plus noise ratio (SINR) or signal to noise ratio (SNR) with total instances where the condition for scheduling into the upper bin is positive limits only (FIG. 15A), limits 0 to 10 (FIG. 15B), limits −5 to 10 (FIG. 15C), and no binning (FIG. 15D) according to some embodiments.

FIG. 16 illustrates an example flowchart for scheduling a UE to RBs according to some embodiments.

FIG. 17 illustrates some embodiments of an example process for scheduling a UE to RBs.

FIG. 18 illustrates some embodiments of an example process for scheduling a UE to RBs.

FIG. 19 illustrates some embodiments of an example process for scheduling a UE to RBs.

FIG. 20 illustrates some embodiments of an example process for scheduling a UE to RBs.

FIG. 21 illustrates some embodiments of an example process for scheduling a UE to RBs.

FIG. 22 illustrates some embodiments of an example process for identifying new bin settings for a BS.

### DETAILED DESCRIPTION

Generally, this disclosure describes techniques to schedule UEs in a mobile network. More specifically, embodiments are directed to techniques to schedule UEs into resource bins (RBs) so that, if there is interference, it is closer to the expected interference. In the following description, numerous specific details are set forth to provide thorough explanation of embodiments of the present disclosure. It will be apparent, however, to one skilled in the art, that embodiments of the present disclosure may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the disclosure. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” may be used to indicate that two or more elements, which may or may not be in direct physical or electrical contact with each other, co-operate or interact with each other. “Connected” may be used to indicate the establishment of communication between two or more elements that are coupled with each other.

The processes depicted in the figures that follow, are performed by processing logic that comprises hardware (e.g., circuitry, dedicated logic, et cetera), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

In some embodiments, a method of wireless communication by a UE includes associating with a BS, measuring reference signals received power (RSRP) data, reporting the RSRP data to the BS, and transmitting on assigned resource blocks (RBs). In some embodiments, the method further comprises receiving signals from the BS, measuring RSRP data from a neighbor BS, and reporting RSRP data from the BS. The signals may comprise one or more of RSRP data and power control. The method may further comprise associating with a new BS.

In some embodiments, a method of wireless communication by a BS for scheduling a user equipment (UE) into resource blocks (RBs) includes receiving updated RB bin sizes from a RAN intelligent controller (RIC), receiving reference signals received power (RSRP) data from user equipments (UEs), scheduling UEs meeting a condition, for example, neigRSRP−servRSRP≤0, to a some group within a specific bin of resource blocks (RBs), scheduling UEs meeting another prespecified “strong neighbor RSRP” condition, such as, for example, neigRSRP−servRSRP>0 to some group within a prespecified (e.g., lower) distinct bin of RBs, receiving traffic data, and reporting the traffic data to the RIC. In other words, the techniques disclosed herein include “binning” those RB groups such that UEs will only be scheduled into a bin of RB groups (or another) based on some condition, e.g., neigRSRP−servRSRP>0 or <=0. The term “neigRSRP” as used herein refers to an RSRP from a UE to a neighbor BS, and the term “servRSRP” as used herein refers to an RSRP received from a UE from the first BS.

In some embodiments, a method for wireless communication by a network for scheduling a user equipment (UE) into resource blocks (RBs) includes initializing base stations (BSs) with no scheduling bin assignment, identifying new bin settings for a BS, transmitting new bin settings to the BSs, and receiving network data from the BSs.

In some embodiments, the method includes updating the bin settings, and transmitting updated bin settings to BSs. The method can further include maintaining the bin settings and reporting the network data to a database.

In some embodiments, identifying new bin settings for a BS includes receiving a historical measurement reports (MR) for BS A; for UEs meeting not meeting the “strong neighbor RSRP” condition, e.g., meeting the condition: neigRSRP−servRSRP≤0 (UE_Ts), obtaining an estimate of RBs required for next period (E[RB]_T), and for UEs meeting the “strong neighbor RSRP” condition, e.g., neigRSRP−servRSRP>0 (UE_Ls), obtaining an estimate of RBs required for next period (E[RB]_L); allocating UE_T using a top bin, wherein the prespecified bin for UEs not meeting the “strong neighbor RSRP” (e.g., top) bin is a continuous block of RBs of size close to T/(T+L) of all RBs available, wherein T=|UE_T|*E[RB]_T, and L=|UE_L|*E[RB]_L, wherein |UE_T| comprises elements of UE_T and |UE_L| comprises elements of UE_L; and allocating UE_L using the prespecified bin for UEs meeting the “strong neighbor RSRP” (e.g., lower) bin, wherein the two bins do not overlap.

Note that in alternative embodiments, instead of using two bins (e.g., top/bottom bins, etc.), more than two bins can be used.

In some embodiments, the MR includes one or more of resource blocks (RBs) utilization data, servRSRP, neigRSRP, and signal to interference plus noise ratio (SINR) values. “Signal to interference and noise ratio” or “SINR” as used herein refers to (signal power)−(interference and noise power). “Signal to noise ratio” or “SNR” as used herein refers to (signal power)−(noise power). SINR or SNR may be measured in dB.

A problem with a pseudo-random, round-robin, or any other scheduler of UEs that does not coordinate scheduling UEs across cells is that the interference a UE expects might be significantly different from the actual interference experienced during transmission. Power control fails when the expected interference is far from the actual interference. If interference to the served UE has been underestimated, the served UE ends up with a poor (high interference) communication link. If it has overestimated interference to the served UE, the transmit power used by the served UE is unnecessarily high, potentially causing unnecessarily high interference to a UE in a nearby cell.

To address the shortcomings in the presently available technology, techniques disclosed herein leverage using local information (e.g., RSRP values, SINR limit), placing a UE within a schedule (e.g., a bin, an RB) such that the expected and actual interference are closer in magnitude, thus leading to significantly better performance. While scheduling can be done via pseudo-random assignment or as guided by channel quality index (CQI) measurements, the scheduler provided herein can be used in tandem with any such approach to the benefit of network control.

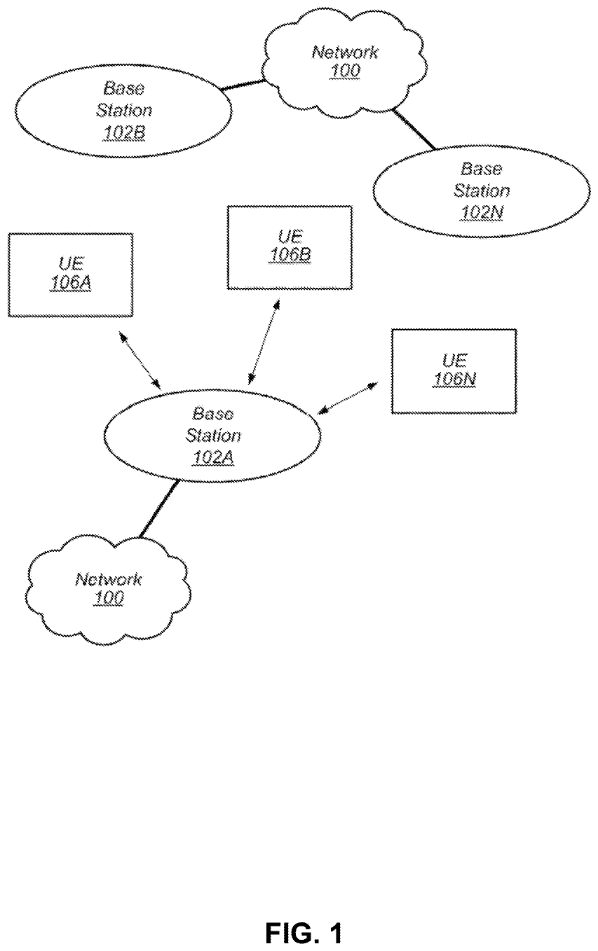

FIG. 1 illustrates a simplified example wireless communication system, according to some embodiments. It is noted that the system of FIG. 1 is merely one example of a possible system, and that features of this disclosure may be implemented in any of various systems, as desired.

As shown, the example wireless communication system includes a base station 102A which communicates over a transmission medium with one or more user devices 106A, 106B, et cetera, through 106N. Each of the user devices may be referred to herein as a “user equipment” (UE) or UE device. Thus, the user devices 106 are referred to as UEs or UE devices.

The base station (BS) 102A may be a base transceiver station (BTS) or cell site (a “cellular base station”) and may include hardware that enables wireless communication with the UEs 106A through 106N.

The communication area (or coverage area) of the base station may be referred to as a “cell.” The base station 102A and the UEs 106 may be configured to communicate over the transmission medium using any of various radio access technologies (RATs), also referred to as wireless communication technologies, or telecommunication standards, such as GSM, UMTS (associated with, for example, WCDMA or TD-SCDMA air interfaces), LTE, LTE-Advanced (LTE-A), 5G new radio (5G NR), HSPA, 3GPP2 CDMA2000 (e.g., 1×RTT, 1×EV-DO, HRPD, eHRPD), 6G, et cetera. Note that if the base station 102A is implemented in the context of LTE, it may alternately be referred to as an ‘eNodeB’ or ‘eNB’. Note that if the base station 102A is implemented in the context of 5G NR, it may alternately be referred to as ‘gNodeB’ or ‘gNB’. A next generation eNB (ng-eNB) may comprise an enhanced version of eNB that connects 5G UE to 5G core network using 4G LTE air interface.

As shown, the base station 102A may also be equipped to communicate with a network 100 (e.g., a core network of a cellular service provider, a telecommunication network such as a public switched telephone network (PSTN), and/or the Internet, among various possibilities). Thus, the base station 102A may facilitate communication between the user devices and/or between the user devices and the network 100. In particular, the cellular base station 102A may provide UEs 106A-N with various telecommunication capabilities, such as voice, SMS and/or data services. It will be appreciated that in various embodiments, the term network may be utilized to collectively refer to one or more devices and components that form the telecommunications network. For example, reference to the network sending or receiving data to/from a UE may refer to one or more portions of the core network of a cellular service provider and/or one or more base stations. In some such examples, data to send to the UE may be determined by core network components and then relayed to the UE via a base station. In other such examples, data to send to the UE may be determined and sent to the UE by a base station.

Base station 102A and other similar base stations (such as base stations 102B 102N) operating according to the same or a different cellular communication standard may thus be provided as a network of cells, which may provide continuous or nearly continuous overlapping service to UEs 106A-N and similar devices over a geographic area via one or more cellular communication standards.

Thus, while base station 102A may act as a “serving cell” for UEs 106A-N as illustrated in FIG. 1, each UE 106 may also be capable of receiving signals from (and possibly within communication range of) one or more other cells (which might be provided by base stations 102B-N and/or any other base stations), which may be referred to as “neighboring cells”. Such cells may also be capable of facilitating communication between user devices and/or between user devices and the network 100. Such cells may include “macro” cells, “micro” cells, “pico” cells, and/or cells which provide any of various other granularities of service area size. For example, base stations 102A-B illustrated in FIG. 1 might be macro cells, while base station 102N might be a micro cell. Other configurations are also possible.

In some embodiments, base station 102A may be a next generation base station, e.g., a 5G New Radio (5G NR) base station, or “gNB”. In some embodiments, a BS may be connected to a legacy evolved packet core (EPC) network and/or to a NR core (NRC) network. In addition, a BS cell may include one or more transition and reception points (TRPs). In addition, a UE capable of operating according to 5G NR may be connected to one or more TRPs within one or more BSs.

Note that a UE 106 may be capable of communicating using multiple wireless communication standards. For example, the UE 106 may be configured to communicate using a wireless networking (e.g., Wi-Fi) and/or peer-to-peer wireless communication protocol (e.g., Bluetooth, Wi-Fi peer-to-peer, etc.) in addition to at least one cellular communication protocol (e.g., GSM, UMTS (associated with, for example, WCDMA or TD-SCDMA air interfaces), LTE, LTE-A, 5G NR, 6G, HSPA, 3GPP2 CDMA2000 (e.g., 1×RTT, 1×EV-DO, HRPD, eHRPD), et cetera). The UE 106 may also or alternatively be configured to communicate using one or more global navigational satellite systems (GNSS, e.g., GPS or GLONASS), one or more mobile television broadcasting standards (e.g., ATSC-M/H or DVB-H), and/or any other wireless communication protocol, if desired. Other combinations of wireless communication standards (including more than two wireless communication standards) are also possible.

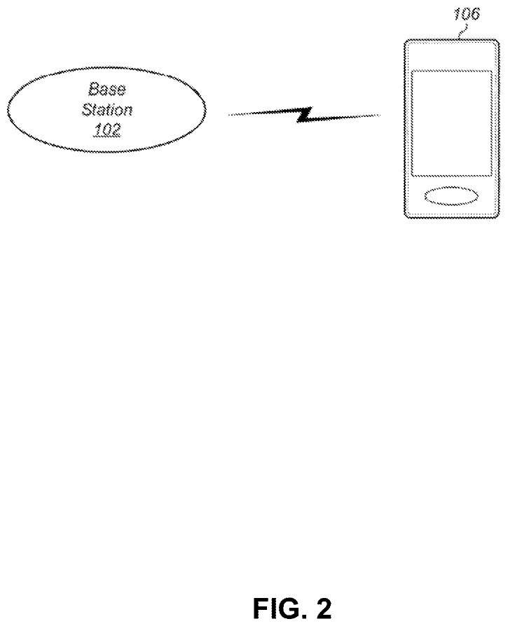

FIG. 2 illustrates UE 106 (e.g., one of the devices 106A through 106N) in communication with a base station 102, according to some embodiments. The UE 106 may be a device with cellular communication capability such as, for example, a mobile phone, a hand-held device, a computer or a tablet, or virtually any type of wireless device.

The UE 106 may include a processor that is configured to execute program instructions stored in memory. The UE 106 may perform any of the functions and/or operations of embodiments described herein by executing such stored instructions. Alternatively, or in addition, the UE 106 may include a programmable hardware element such as an FPGA (field-programmable gate array) that is configured to perform any of the embodiments described herein, or any portion of any of the embodiments described herein.

The UE 106 may include one or more antennas for communicating using one or more wireless communication protocols or technologies. In some embodiments, the UE 106 may be configured to communicate using, for example, 5G NR, CDMA2000 (1×RTT/1×EV-DO/HRPD/eHRPD), 6G, or LTE using a single shared radio and/or GSM or LTE using the single shared radio. The shared radio may couple to a single antenna, or may couple to multiple antennas (e.g., for MIMO) for performing wireless communications. In general, a radio may include any combination of a baseband processor, analog RF signal processing circuitry (e.g., including filters, mixers, oscillators, amplifiers, etc.), or digital processing circuitry (e.g., for digital modulation as well as other digital processing). Similarly, the radio may implement one or more receive and transmit chains using the aforementioned hardware. For example, the UE 106 may share one or more parts of a receive and/or transmit chain between multiple wireless communication technologies, such as those discussed above.

In some embodiments, the UE 106 may include separate transmit and/or receive chains (e.g., including separate antennas and other radio components) for each wireless communication protocol with which it is configured to communicate. As a further possibility, the UE 106 may include one or more radios which are shared between multiple wireless communication protocols, and one or more radios which are used exclusively by a single wireless communication protocol. For example, the UE 106 might include a shared radio for communicating using either of LTE or 5G NR (or LTE or 1×RTT or LTE or GSM or 6G), and separate radios for communicating using each of Wi-Fi and Bluetooth. Other configurations are also possible.

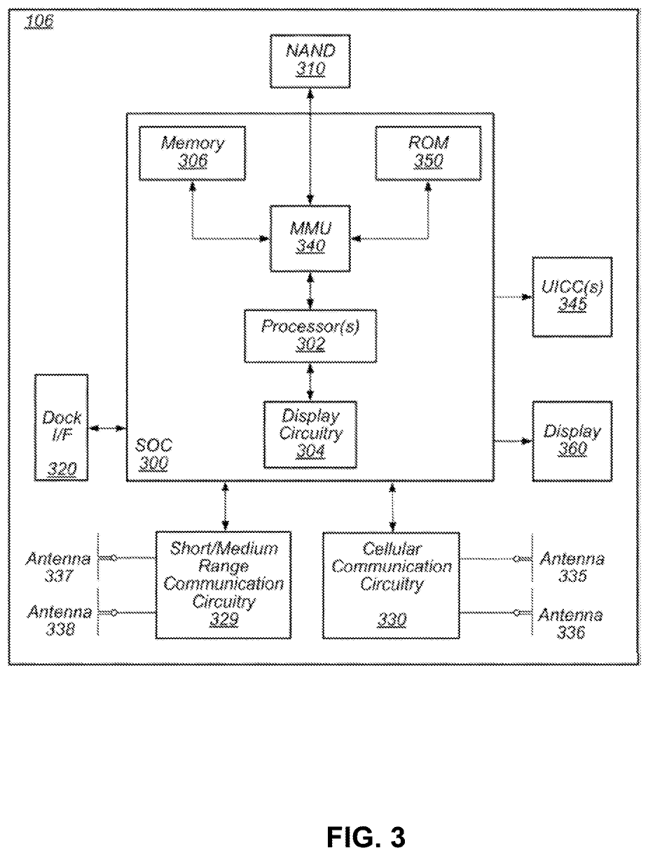

FIG. 3 illustrates an example simplified block diagram of UE (communication device) 106, according to some embodiments. It is noted that the block diagram of the communication device of FIG. 3 is only one example of a possible communication device. According to embodiments, UE 106 may be a user equipment (UE) device, a mobile device or mobile station, a wireless device or wireless station, a desktop computer or computing device, a mobile computing device (e.g., a laptop, notebook, or portable computing device), a tablet and/or a combination of devices, among other devices. As shown, the UE 106 may include a set of components 300 configured to perform core functions. For example, this set of components may be implemented as a system on chip (SOC), which may include portions for various purposes. Alternatively, this set of components 300 may be implemented as separate components or groups of components for the various purposes. The set of components 300 may be coupled (e.g., communicatively; directly or indirectly) to various other circuits of the communication device 106.

For example, the UE 106 may include various types of memory (e.g., including NAND flash 310), an input/output interface such as connector I/F 320 (e.g., for connecting to a computer system; dock; charging station; input devices, such as a microphone, camera, keyboard; output devices, such as speakers; etc.), the display 360, which may be integrated with or external to the communication device 106, and cellular communication circuitry 330 such as for 5G NR, LTE, GSM, etc., and short to medium range wireless communication circuitry 329 (e.g., Bluetooth™ and WLAN circuitry). In some embodiments, UE 106 may include wired communication circuitry (not shown), such as a network interface card, e.g., for Ethernet.

The cellular communication circuitry 330 may couple (e.g., communicatively; directly or indirectly) to one or more antennas, such as antennas 335 and 336 as shown. The short to medium range wireless communication circuitry 329 may also couple (e.g., communicatively; directly or indirectly) to one or more antennas, such as antennas 337 and 338 as shown. Alternatively, the short to medium range wireless communication circuitry 329 may couple (e.g., communicatively; directly or indirectly) to the antennas 335 and 336 in addition to, or instead of, coupling (e.g., communicatively; directly or indirectly) to the antennas 337 and 338. The short to medium range wireless communication circuitry 329 and/or cellular communication circuitry 330 may include multiple receive chains and/or multiple transmit chains for receiving and/or transmitting multiple spatial streams, such as in a multiple-input multiple output (MIMO) configuration.

In some embodiments, as further described below, cellular communication circuitry 330 may include dedicated receive chains (including and/or coupled to, e.g., communicatively; directly or indirectly, dedicated processors and/or radios) for multiple radio access technologies (RATs) (e.g., a first receive chain for LTE and a second receive chain for 5G NR). In addition, in some embodiments, cellular communication circuitry 330 may include a single transmit chain that may be switched between radios dedicated to specific RATs. For example, a first radio may be dedicated to a first RAT, e.g., LTE, and may be in communication with a dedicated receive chain and a transmit chain shared with an additional radio, e.g., a second radio that may be dedicated to a second RAT, e.g., 5G NR, and may be in communication with a dedicated receive chain and the shared transmit chain.

The UE 106 may also include and/or be configured for use with one or more user interface elements. The user interface elements may include any of various elements, such as display 360 (which may be a touchscreen display), a keyboard (which may be a discrete keyboard or may be implemented as part of a touchscreen display), a mouse, a microphone and/or speakers, one or more cameras, one or more buttons, and/or any of various other elements capable of providing information to a user and/or receiving or interpreting user input.

The UE 106 may further include one or more smart cards 345 that include SIM (Subscriber Identity Module) functionality, such as one or more UICC(s) (Universal Integrated Circuit Card(s)) cards 345.

As shown, the SOC 300 may include processor(s) 302, which may execute program instructions for the UE 106 and display circuitry 304, which may perform graphics processing and provide display signals to the display 360. The processor(s) 302 may also be coupled to memory management unit (MMU) 340, which may be configured to receive addresses from the processor(s) 302 and translate those addresses to locations in memory (e.g., memory 306, read only memory (ROM) 350, NAND flash memory 310) and/or to other circuits or devices, such as the display circuitry 304, short range wireless communication circuitry 229, cellular communication circuitry 330, connector I/F 320, and/or display 360. The MMU 340 may be configured to perform memory protection and page table translation or set up. In some embodiments, the MMU 340 may be included as a portion of the processor(s) 302.

As noted above, the UE 106 may be configured to communicate using wireless and/or wired communication circuitry. The UE 106 may be configured to transmit a request to attach to a first network node operating according to the first RAT (e.g., 5G NR, 4G LTE, Bluetooth, Wi-Fi, et cetera) and transmit an indication that the wireless device is capable of maintaining substantially concurrent connections with the first network node and a second network node that operates according to the second RAT (e.g., 5G NR, 4G LTE, Bluetooth, Wi-Fi, et cetera). The wireless device may also be configured transmit a request to attach to the second network node. The request may include an indication that the wireless device is capable of maintaining substantially concurrent connections with the first and second network nodes. Further, the wireless device may be configured to receive an indication that dual connectivity with the first and second network nodes has been established.

As described herein, the UE 106 may include hardware and software components for implementing the above features for supporting DGL transmissions. The processor 302 of the UE 106 may be configured to implement part or all of the features described herein, e.g., by executing program instructions stored on a memory medium (e.g., a non-transitory computer-readable memory medium). Alternatively (or in addition), processor 302 may be configured as a programmable hardware element, such as an FPGA (Field Programmable Gate Array), or as an ASIC (Application specific Integrated Circuit). Alternatively (or in addition) the processor 302 of the UE 106, in conjunction with one or more of the other components 300, 304, 306, 310, 320, 329, 330, 340, 345, 350, 360 may be configured to implement part or all of the features described herein.

In addition, as described herein, processor 302 may include one or more processing elements. Thus, processor 302 may include one or more integrated circuits (ICs) that are configured to perform the functions of processor 302. In addition, each integrated circuit may include circuitry (e.g., first circuitry, second circuitry, et cetera) configured to perform the functions of processor(s) 302.

Further, as described herein, cellular communication circuitry 330 and short range wireless communication circuitry 329 may each include one or more processing elements. In other words, one or more processing elements may be included in cellular communication circuitry 330 and, similarly, one or more processing elements may be included in short range wireless communication circuitry 329. Thus, cellular communication circuitry 330 may include one or more integrated circuits (ICs) that are configured to perform the functions of cellular communication circuitry 330. In addition, each integrated circuit may include circuitry (e.g., first circuitry, second circuitry, et cetera) configured to perform the functions of cellular communication circuitry 330. Similarly, the short range wireless communication circuitry 329 may include one or more ICs that are configured to perform the functions of short range wireless communication circuitry 329. In addition, each integrated circuit may include circuitry (e.g., first circuitry, second circuitry, et cetera) configured to perform the functions of short range wireless communication circuitry 329.

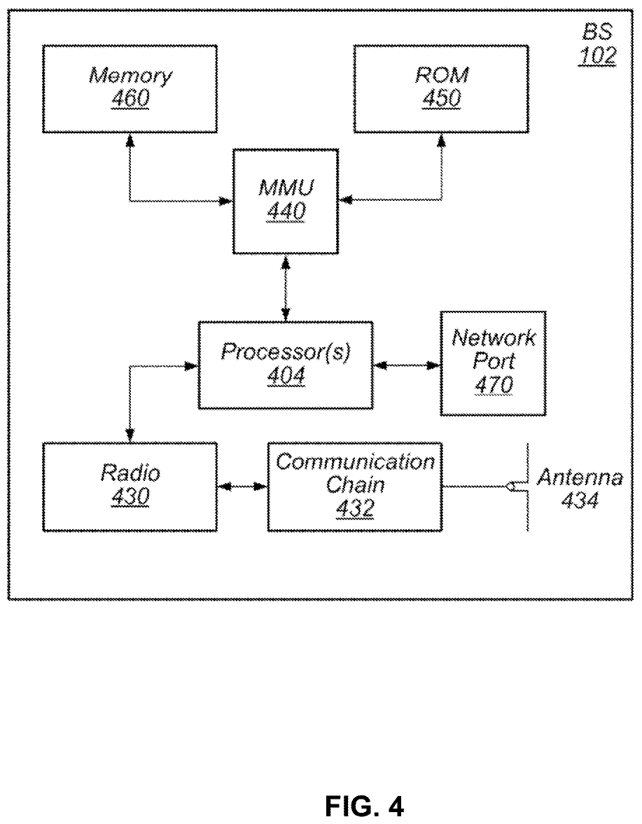

FIG. 4 illustrates an example block diagram of a base station 102, according to some embodiments. It is noted that the base station of FIG. 4 is merely one example of a possible base station. As shown, the base station 102 may include processor(s) 404 which may execute program instructions for the base station 102. The processor(s) 404 may also be coupled to memory management unit (MMU) 440, which may be configured to receive addresses from the processor(s) 404 and translate those addresses to locations in memory (e.g., memory 460 and read only memory (ROM) 450) or to other circuits or devices.

The base station 102 may include at least one network port 470. The network port 470 may be configured to couple to a telephone network and provide a plurality of devices, such as UE devices 106, access to the telephone network as described above in FIGS. 1 and 2.

The network port 470 (or an additional network port) may also or alternatively be configured to couple to a cellular network, e.g., a core network of a cellular service provider. The core network may provide mobility related services and/or other services to a plurality of devices, such as UE devices 106. In some cases, the network port 470 may couple to a telephone network via the core network, and/or the core network may provide a telephone network (e.g., among other UE devices serviced by the cellular service provider).

In some embodiments, base station 102 may be a next generation base station, e.g., a 5G New Radio (5G NR) base station, or “next generation Node B,” “gNodeB,” “gNB”. In such embodiments, base station 102 may be connected to a legacy evolved packet core (EPC) network and/or to a NR core (NRC) network. In addition, base station 102 may be considered a 5G NR cell and may include one or more transition and reception points (TRPs). In addition, a UE capable of operating according to 5G NR may be connected to one or more TRPs within one or more gNBs.

The base station 102 may include at least one antenna 434, and possibly multiple antennas, such as an array of antennas. These antennas may be configured to operate as a wireless transceiver and may be further configured to communicate with UE devices 106 via radio 430. The antenna 434 communicates with the radio 430 via communication chain 432. Communication chain 432 may be a receive chain, a transmit chain or both. The radio 430 may be configured to communicate via various wireless communication standards, including, but not limited to, 5G NR, LTE, LTE-A, GSM, UMTS, CDMA2000, Wi-Fi, etc.

The base station 102 may be configured to communicate wirelessly using multiple wireless communication standards. In some instances, the base station 102 may include multiple radios, which may enable the base station 102 to communicate according to multiple wireless communication technologies. For example, as one possibility, the base station 102 may include an LTE radio for performing communication according to LTE as well as a 5G NR radio for performing communication according to 5G NR. In such a case, the base station 102 may be capable of operating as both an LTE base station and a 5G NR base station. As another possibility, the base station 102 may include a multi-mode radio which is capable of performing communications according to any of multiple wireless communication technologies (e.g., 5G NR and Wi-Fi, LTE and Wi-Fi, LTE and UMTS, LTE and CDMA2000, UMTS and GSM, etc.).

As described further subsequently herein, the BS 102 may include hardware and software components for implementing or supporting implementation of features described herein. The processor 404 of the base station 102 may be configured to implement or support implementation of part or all of the methods described herein, e.g., by executing program instructions stored on a memory medium (e.g., a non-transitory computer-readable memory medium). Alternatively, the processor 404 may be configured as a programmable hardware element, such as an FPGA (Field Programmable Gate Array), or as an ASIC (Application specific Integrated Circuit), or a combination thereof. Alternatively (or in addition) the processor 404 of the BS 102, in conjunction with one or more of the other components 430, 432, 434, 440, 450, 460, 470 may be configured to implement or support implementation of part or all of the features described herein.

In addition, as described herein, processor(s) 404 may be comprised of one or more processing elements. In other words, one or more processing elements may be included in processor(s) 404. Thus, processor(s) 404 may include one or more integrated circuits (ICs) that are configured to perform the functions of processor(s) 404. In addition, each integrated circuit may include circuitry (e.g., first circuitry, second circuitry, etc.) configured to perform the functions of processor(s) 404.

Further, as described herein, radio 430 may be comprised of one or more processing elements. In other words, one or more processing elements may be included in radio 430. Thus, radio 430 may include one or more integrated circuits (ICs) that are configured to perform the functions of radio 430. In addition, each integrated circuit may include circuitry (e.g., first circuitry, second circuitry, etc.) configured to perform the functions of radio 430.

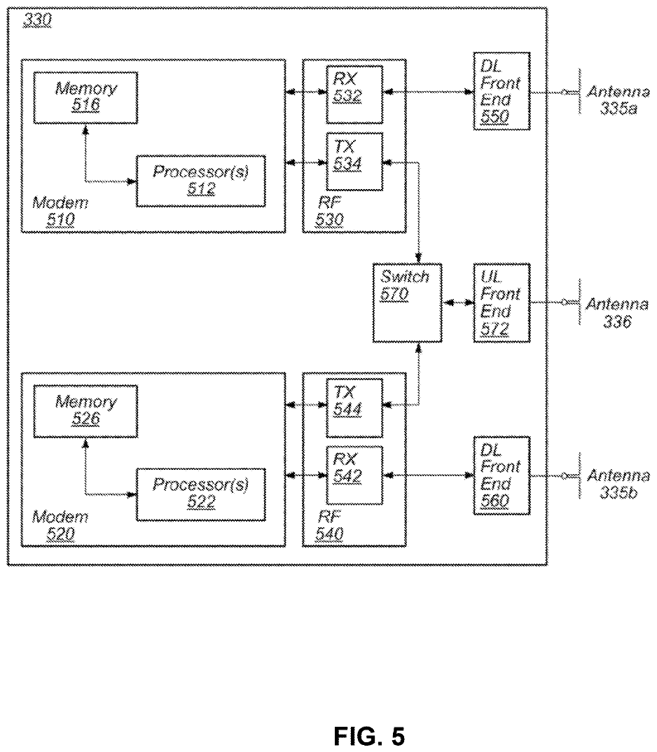

FIG. 5 illustrates an example simplified block diagram of cellular communication circuitry, according to some embodiments. It is noted that the block diagram of the cellular communication circuitry of FIG. 5 is only one example of a possible cellular communication circuit. According to embodiments, cellular communication circuitry 330 may be included in a communication device, such as UE 106 described above. As noted above, UE 106 may be, for example, a mobile device or mobile station, a wireless device or wireless station, a desktop computer or computing device, a mobile computing device (e.g., a laptop, notebook, or portable computing device), a tablet and/or a combination of devices, among other devices.

The cellular communication circuitry 330 may couple (e.g., communicatively; directly or indirectly) to one or more antennas, such as antennas 335a-b and 336 as shown. In some embodiments, cellular communication circuitry 330 may include dedicated receive chains (including and/or coupled to, e.g., communicatively; directly or indirectly, dedicated processors and/or radios) for multiple RATs (e.g., a first receive chain for LTE and a second receive chain for 5G NR). For example, as shown in FIG. 5, cellular communication circuitry 330 may include a modem 510 and a modem 520. Modem 510 may be configured for communications according to a first RAT, e.g., such as LTE or LTE-A, and modem 520 may be configured for communications according to a second RAT, e.g., such as 5G NR.

As shown, modem 510 may include one or more processors 512 and a memory 516 in communication with processors 512. Modem 510 may be in communication with a radio frequency (RF) front end 530. RF front end 530 may include circuitry for transmitting and receiving radio signals. For example, RF front end 530 may include receive circuitry (RX) 532 and transmit circuitry (TX) 534. In some embodiments, receive circuitry 532 may be in communication with downlink (DL) front end 550, which may include circuitry for receiving radio signals via antenna 335a.

Similarly, modem 520 may include one or more processors 522 and a memory 526 in communication with processors 522. Modem 520 may be in communication with an RF front end 540. RF front end 540 may include circuitry for transmitting and receiving radio signals. For example, RF front end 540 may include receive circuitry 542 and transmit circuitry 544. In some embodiments, receive circuitry 542 may be in communication with DL front end 560, which may include circuitry for receiving radio signals via antenna 335b.

In some embodiments, a switch 570 may couple transmit circuitry 534 to uplink (UL) front end 572. In addition, switch 570 may couple transmit circuitry 544 to UL front end 572. UL front end 572 may include circuitry for transmitting radio signals via antenna 336. Thus, when cellular communication circuitry 330 receives instructions to transmit according to the first RAT (e.g., as supported via modem 510), switch 570 may be switched to a first state that allows modem 510 to transmit signals according to the first RAT (e.g., via a transmit chain that includes transmit circuitry 534 and UL front end 572). Similarly, when cellular communication circuitry 330 receives instructions to transmit according to the second RAT (e.g., as supported via modem 520), switch 570 may be switched to a second state that allows modem 520 to transmit signals according to the second RAT (e.g., via a transmit chain that includes transmit circuitry 544 and UL front end 572).

As described herein, the modem 510 may include hardware and software components for implementing the above features or for supporting DGL transmissions, as well as the various other techniques described herein. The processors 512 may be configured to implement part or all of the features described herein, e.g., by executing program instructions stored on a memory medium (e.g., a non-transitory computer-readable memory medium). Alternatively (or in addition), processor 512 may be configured as a programmable hardware element, such as an FPGA (Field Programmable Gate Array), or as an ASIC (Application specific Integrated Circuit). Alternatively (or in addition) the processor 512, in conjunction with one or more of the other components 530, 532, 534, 550, 570, 572, 335 and 336 may be configured to implement part or all of the features described herein.

In addition, as described herein, processors 512 may include one or more processing elements. Thus, processors 512 may include one or more integrated circuits (ICs) that are configured to perform the functions of processors 512. In addition, each integrated circuit may include circuitry (e.g., first circuitry, second circuitry, et cetera) configured to perform the functions of processors 512.

As described herein, the modem 520 may include hardware and software components for implementing the above features for supporting DGL transmissions, as well as the various other techniques described herein. The processors 522 may be configured to implement part or all of the features described herein, e.g., by executing program instructions stored on a memory medium (e.g., a non-transitory computer-readable memory medium). Alternatively (or in addition), processor 522 may be configured as a programmable hardware element, such as an FPGA (Field Programmable Gate Array), or as an ASIC (Application specific Integrated Circuit). Alternatively (or in addition) the processor 522, in conjunction with one or more of the other components 540, 542, 544, 550, 570, 572, 335 and 336 may be configured to implement part or all of the features described herein.

In addition, as described herein, processors 522 may include one or more processing elements. Thus, processors 522 may include one or more integrated circuits (ICs) that are configured to perform the functions of processors 522. In addition, each integrated circuit may include circuitry (e.g., first circuitry, second circuitry, et cetera) configured to perform the functions of processors 522.

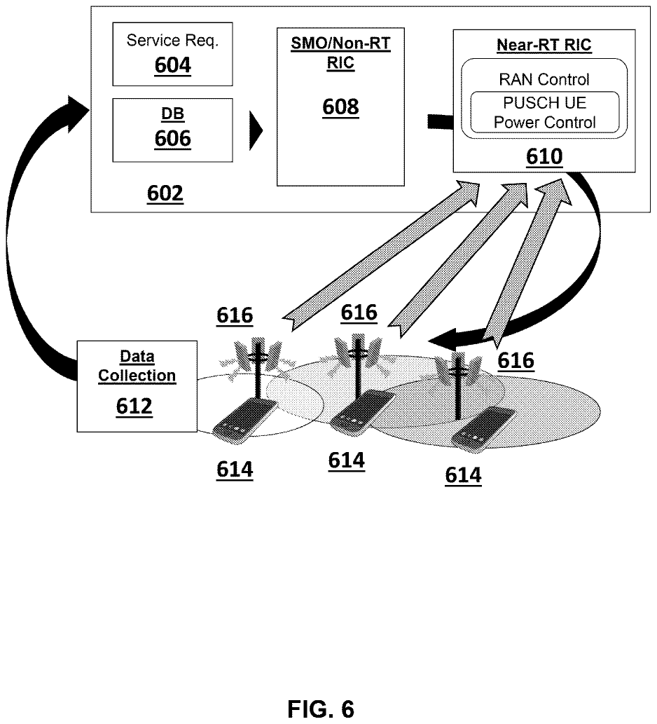

FIG. 6 illustrates an example diagram of open radio access network (O-RAN) architecture. O-RAN 602 includes database (DB) 606 with service requirements 604, service management and orchestration/non-real time RAN intelligent controller (SMO/non-RT RIC) 608, and near-RT RIC 610. DB 606 contains and controls network log/network traffic and BS (e.g., gNodeB (gNB)) information. SMO/non-RT RIC 608 conducts control policy optimization, parameter optimization, and executes parameter plan. Near-RT RIC 610 conducts RAN control and PUSCH UE power control. “PUSCH” as used herein refers to a channel used for uplink (i.e., from UE to BS) transmission of data. “Power control” as used herein refers to controlling the UE's transmission power. SMO/non-RT RIC 608 or near-RT RIC 610 transmits signals to BS 616. UE 614 associates with BS 616. BS 616 transmits data for near RT-RIC 610. BS 616 also collects data 612, such as terminal report and gNB report, and transmits the data to DB 606.

As used herein, E-UTRAN cell identity (ECI) refers to a unique identifier assigned to each individual cell within an LTE network, composed of the eNodeB ID and the physical cell ID, acting as a cell ID that allows mobile devices to identify and connect to a specific BS (cell tower) for communication. In some embodiments provided herein, a BS may be an ECI. In some embodiments, an ECI may refer to a BS. Note that, in contrast to an ECI, a PCI value for a cell is selected during network planning and is not part of the ECI value given to a cell. Also PCIs are reused, but not ECIs. One goal of assigning PCIs in the network is that they are locally unique in any given frequency band.

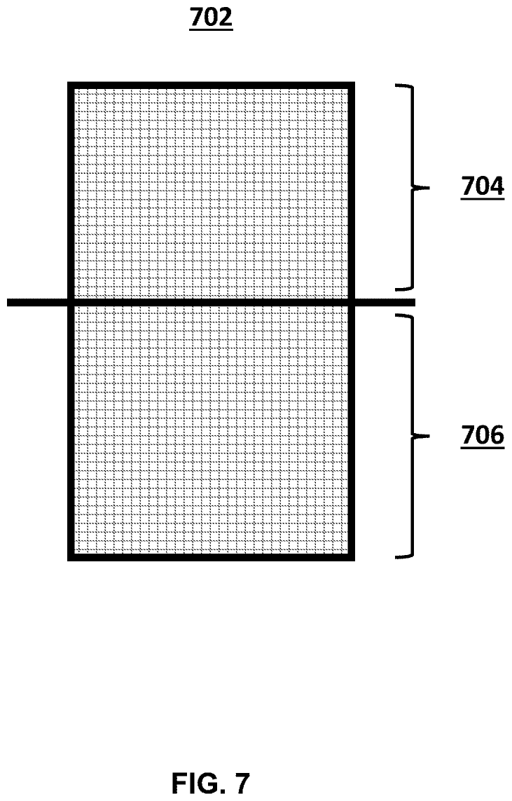

FIG. 7 illustrates example resource blocks (RBs) to shape interference. RBs 702 includes the top bin 704 and the bottom bin 706. Upon association with UEs, the BS and the controller receive neigRSRP and servRSRP of each UE. UEs may be scheduled into the top bin 704 or the bottom bin 706 based on certain measurement data, e.g., RSRP values. In some embodiments, when a BS expects that a UE associated with the BS will cause more interference (e.g., signal with no value to the receiver) than information (i.e., signal with value to the receiver), then the BS put that UE in a different RB bin. For example:
All UEs for which, e.g., if “0<=|neigRSRP|−|servRSRP|” is true get assigned the top bin 704; and
All other UEs get assigned the bottom bin 706.

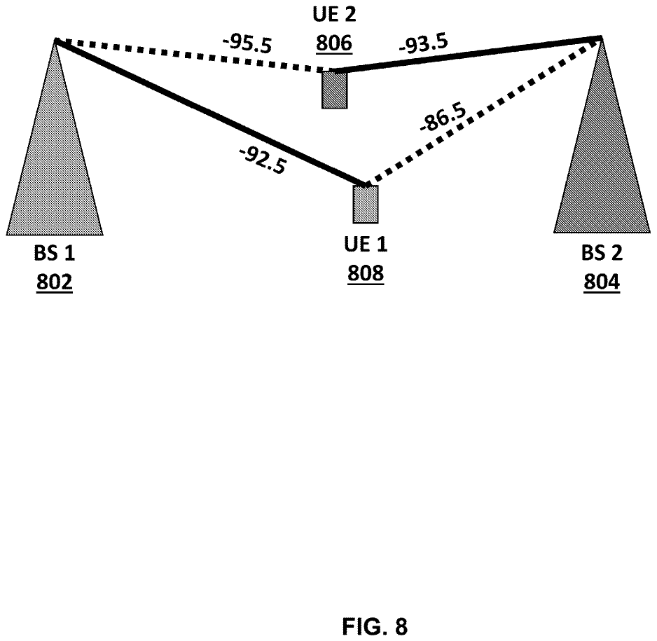

FIG. 8 illustrates an example diagram of UE's signals and interference. A BS can identify its associated UE channels and expected interference. For example, with local information, BS 802 knows UE 808's signal will introduce more interference than not into the network. With local information, BS 804 knows UE 806's signal will introduce a little less interference than not into the network. In some embodiments, an BS signals to one of its UEs to increase their power to protect from some expected interference. This can lead to higher interference elsewhere in the network.

An BS can protect the network by separating into RB bins the UEs that have a signal that will create large amounts of interference separate from the UEs with a signal that will not create large amounts of interference. For example, BS 802 can separate UE 808 into RB bins separate from the UE's whose signal will not create large amounts of interference. BS 804 can separate UE 806 into RB bins separate from the UEs whose signal is expected to create large amounts of interference.

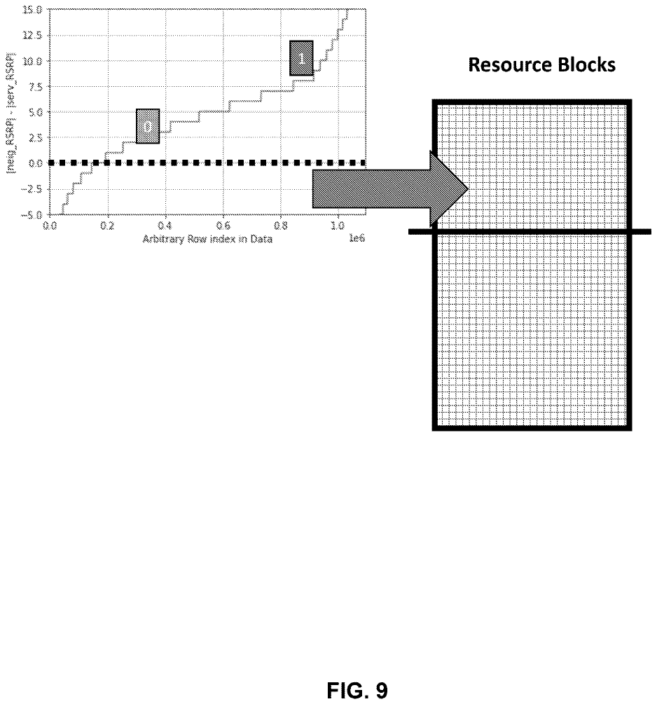

FIG. 9 schematically illustrates scheduling bins to shape interference according to some embodiments. In some embodiments, the scheduling bins users with similar “neigRSRP-servRSRP” such that if interference happens then both UE's can reach 5 dB SINR (i.e., since the sum Target limit is close to 10 dB). These UEs set their power expecting a low or medium amount of interference power, and are likely to experience such. In this case, the UEs can be scheduled into the upper bin.

The 5 and 10 dB above are inferred from network data. These values serve as an example and not meant as exact values to be used everywhere. In some other embodiments, other values can be used. In some embodiments, the limit is defined as:
Limit=neigRSRP0−servRSRP0+neigRSRP1−servRSRP1
For example, for UE 1, neigRSRP=−70, servRSRP=−60
For example, for UE 2, neigRSRP=−92, servRSRP=−88

In some embodiments, UE1 and UE2 are scheduled into the upper bin for the expected low or medium interference.

Binning is not selecting interfering UEs. Instead, binning separates the UEs such that the expected interference and the actual interference are similar in value. Inside each “bin”, the RB assignment can be pseudo-random or according to other existing approaches.

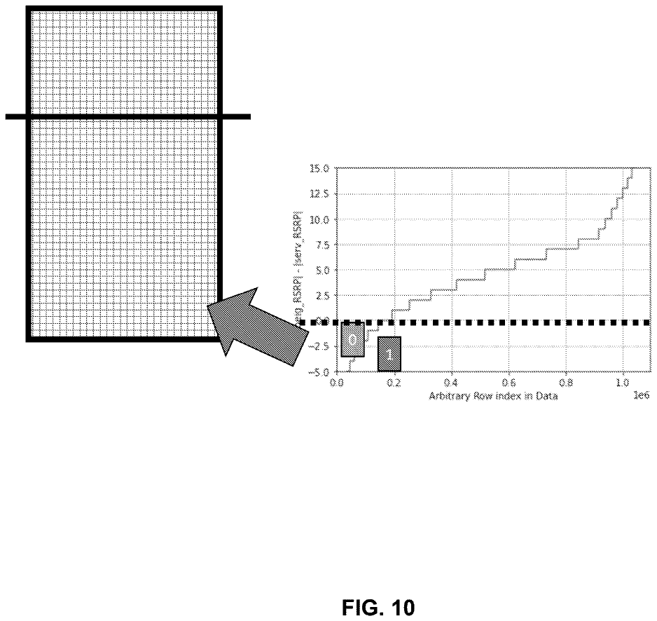

FIG. 10 schematically illustrates some embodiments of a process for scheduling bins to shape interference. Referring to FIG. 10, UEs are binned that will generate high interference together, such that they set powers expecting high interference power and they get high interference power. In some embodiments, the limit is defined as:
Limit=neigRSRP0−servRSRP0+neigRSRP1−servRSRP1.
For example, for UE1, neigRSRP=−60, serv_RSRP=−62.
For example, for UE2, neigRSRP=−94, servRSRP=−96 UE1 and UE2 are scheduled into the lower bin for expected high interference.

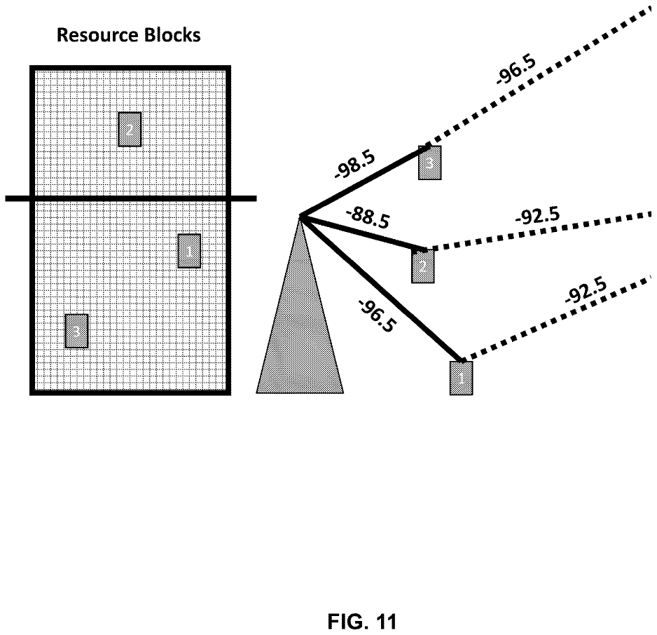

FIG. 11 illustrates an example of scheduling UEs into bins from a BS's perspective according to some embodiments. In some embodiments, the gNB that controls UE 2 schedules some RBs for its traffic in the top bin (above the line). Similarly, the gNB schedules some RBs to UE1 and UE2 for their traffic in the bottom bin (below the line).

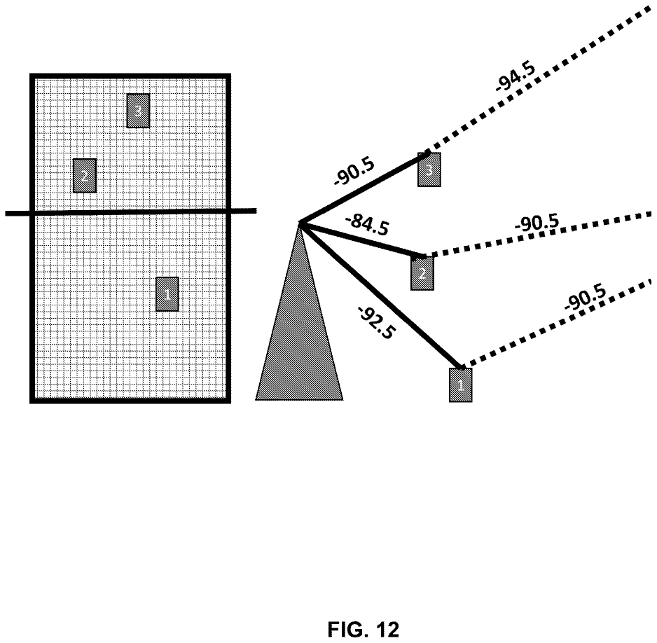

FIG. 12 illustrates an example of scheduling UEs into bins from a BS's perspective according to some embodiments. In some embodiments, the gNB that controls UE 2 and UE 3 schedules them some RBs in the top bin (above the line). Similarly, the gNB schedules some RBs in the bottom bin (below the line) for UE1.

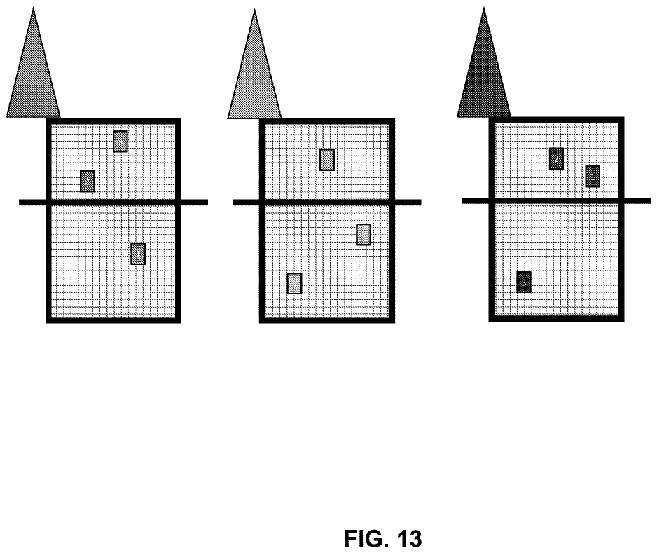

FIG. 13 illustrates an example of scheduling UEs into bins according to some embodiments. In this example, in some embodiments, each BS bins UEs, such that if interference occurs, it is close to the expected interference. Scheduling provided herein does not split up RBs by BS. Each BS uses all the available RBs. The allocation of RBs within a bin is assumed to be pseudo-random.

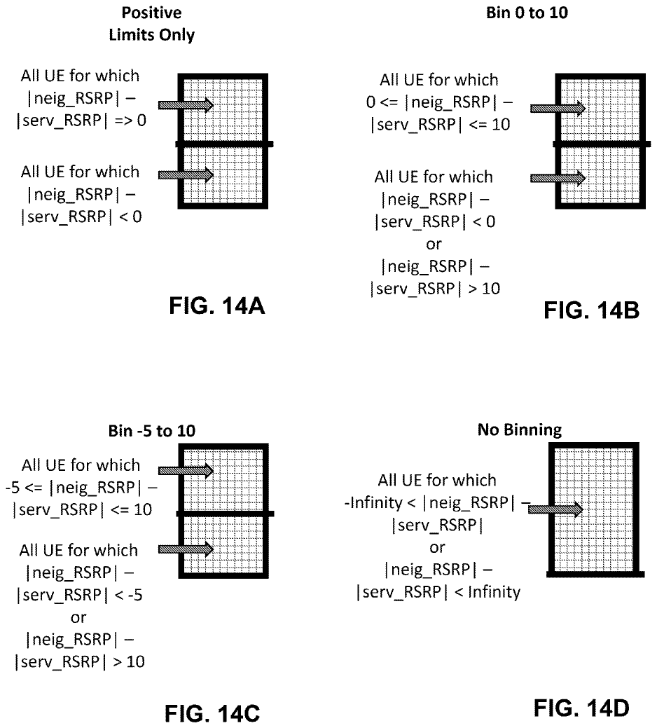

In some embodiments, the threshold or condition for scheduling a UE into the upper bin or the lower bin would impact the probability of interference and also depends on traffic. FIGS. 14A-14D illustrate some embodiments of an example process of scheduling UEs into bins.

In FIG. 14A, the condition for scheduling UEs into upper bins is positive limits only. In this case, all UEs for which |neig_RSRP|−|serv_RSRP|>=0 are scheduled into the upper bin, and all UEs for which |neig_RSRP|-|serv_RSRP|<0 are scheduled into the lower bin. Note that in some other embodiments, values other than 0 can be used.

In FIG. 14B, the condition for scheduling UEs into upper bins is |neigRSRP|−|servRSRP| between 0 to 10. In this case, all UEs for which 0<=|neig_RSRP|−|serv_RSRP|<=10 are scheduled into the upper bin, and all UEs for which |neig_RSRP|−|serv_RSRP|<0 or |neig_RSRP|−|serv_RSRP|>10 are scheduled into the lower bin. Note that in some other embodiments, values other than 0 and 10 can be used.

In FIG. 14C, the condition for scheduling UEs into upper bins is |neigRSRP|−|servRSRP| between −5 to 10. In this case, all UEs for which-5<=|neig_RSRP|-|serv_RSRP| <=10 are scheduled into the upper bin, and all UEs for which |neig_RSRP|−|serv_RSRP|<−5 or |neig_RSRP|-|serv_RSRP|>10 are scheduled into the lower bin. Note that in some other embodiments, values other than 0 and 10 can be used.

In FIG. 14D, no binning is conducted.

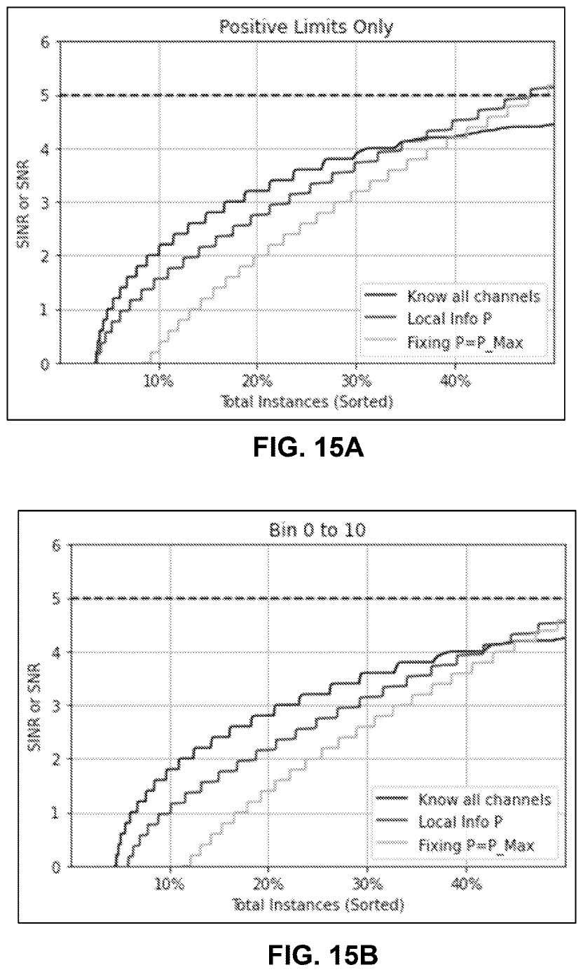

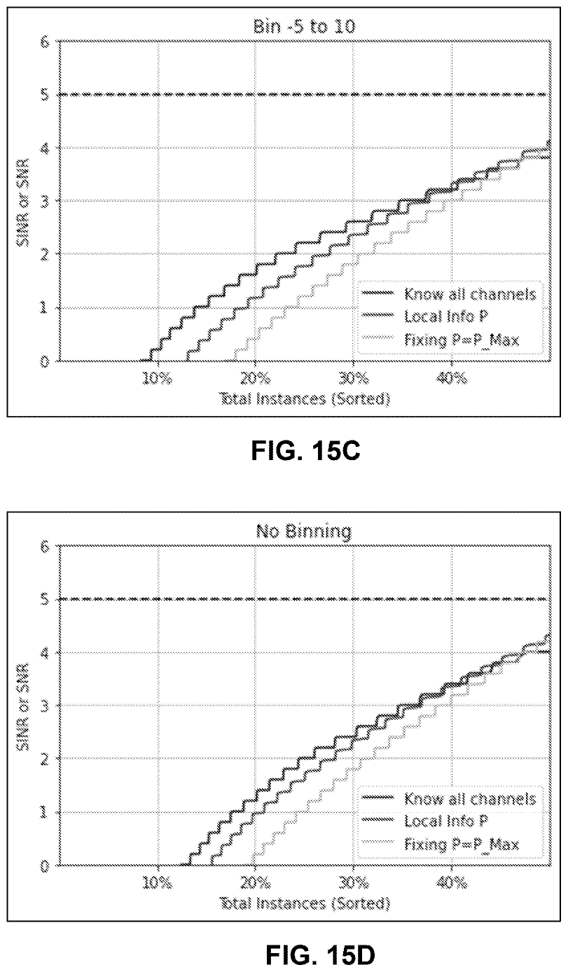

FIGS. 15A-15D illustrates the relationship of the signal to interference plus noise ratio (SINR) or signal to noise ratio (SNR) with total instances where the condition for scheduling into the upper bin is positive limits only (FIG. 15A), limits 0 to 10 (FIG. 15B), limits −5 to 10 (FIG. 15C), and no binning (FIG. 15D), where limits are |neig_RSRP|-|serv_RSRP|. Local info P, Pmax, and saving by power control for each binning schedule are as follows:

| | lim- | 0 ≤ lim- | −5 ≤ lim- | No |
|---|---|---|---|---|
| | its >= 0 | its ≤ 10 | its ≤ 10 | binning |
| local | 3.8% < | 5.8% < | 13.1% < | 15.6% < |
| info P | 0 dB | 0 dB | 0 dB | 0 dB |
| | SINR | SINR | SINR | SINR |
| P_max | 9.2% < | 12.1% < | 17.9% < | 19.7% < |
| | 0 dB | 0 dB | 0 dB | 0 dB |
| | SINR | SINR | SINR | SINR |
| % saving | 5.4 | 6.3 | 4.8 | 4.1 |
| by power | | | | |
| control | | | | |

When comparing positive limits only and no binning, in some embodiments, control of the schedules saves 11.8%.

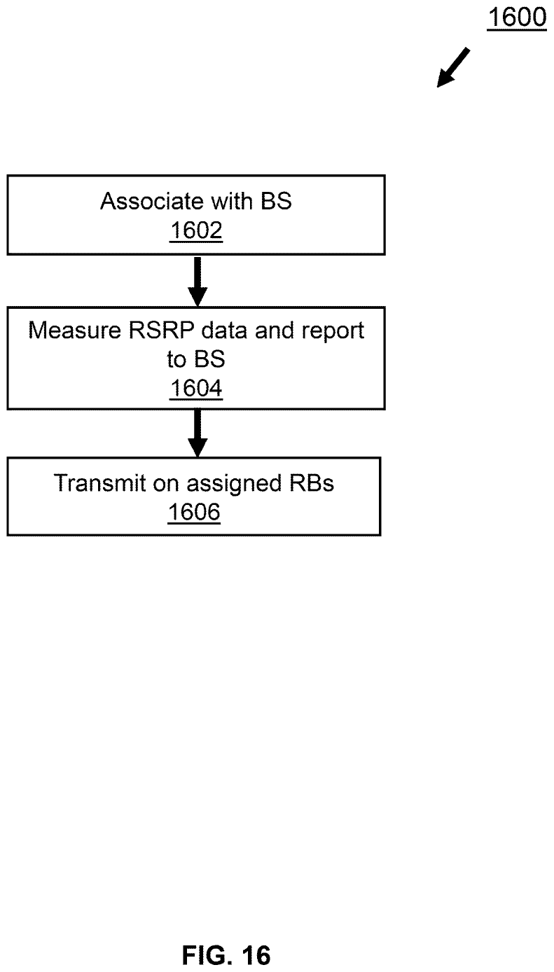

FIG. 16 illustrates some embodiments of a process for wireless communication by a UE for scheduling the UE to RBs. Referring to FIG. 16, process 1600 for method of wireless communication by a UE begins at processing block 1602 where processing logic associates the UE with a first BS. Process 1600 continues at processing block 1604, where processing logic of the UE measures data for RSRP to the first BS and reports the RSRP data to the first BS. Process 1600 further continues to processing block 1606 where processing logic transmits on assigned RBs.

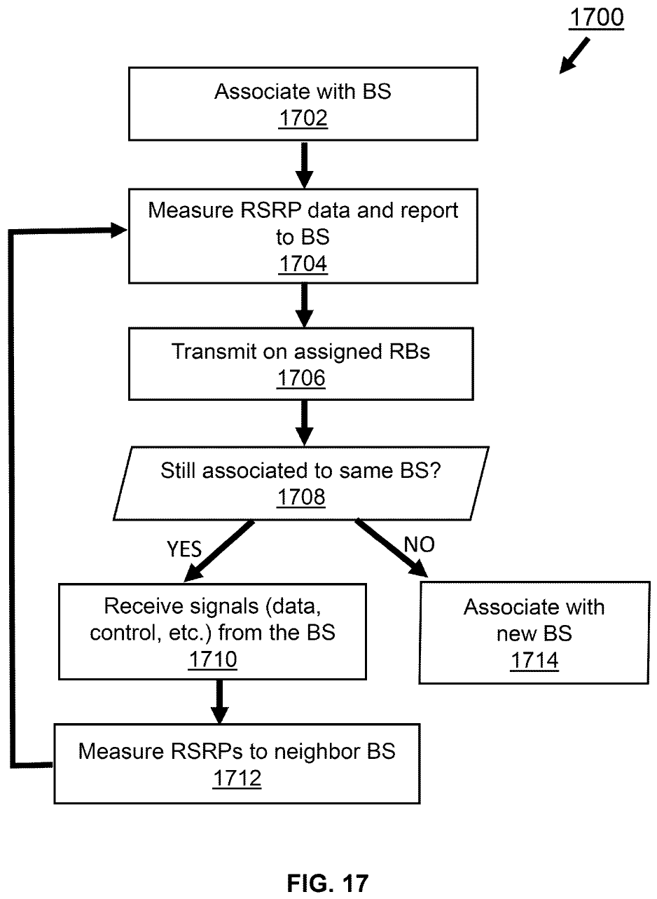

FIG. 17 illustrates some embodiments of a process for wireless communication by a UE for scheduling a UE to RBs. Referring to FIG. 17, process 1700 for method of wireless communication by a UE begins at processing block 1702 where processing logic associates the UE with a first BS. Process 1700 then continues to processing block 1702, where processing logic of the UE measures data for RSRP to the first BS (servRSRP) and reports the RSRP data to the first BS. Process 1700 further continues at processing block 1706 where processing logic transmits on assigned RBs. Thereafter, process 1700 continues at processing block 1708, where processing logic verifies whether the UE is still associated with the same BS. If the UE is still associated with the same BS, process 1700 transitions to processing block 1710 where processing logic receives signals (e.g., data, control) from the same BS. Process 1700 continues at processing block 1712 where processing logic measures RSRPs to a neighbor BS (neigRSRP) and then at processing block 1704 where processing logic measures RSRP to the serving BS and reports neigRSRP and servRSRP to the first BS. If the UE is not still associated with the same BS, process 1700 transitions to processing block 1714 where processing logic of the UE associates with a new BS. Process 1700 may continue through the steps described herein.

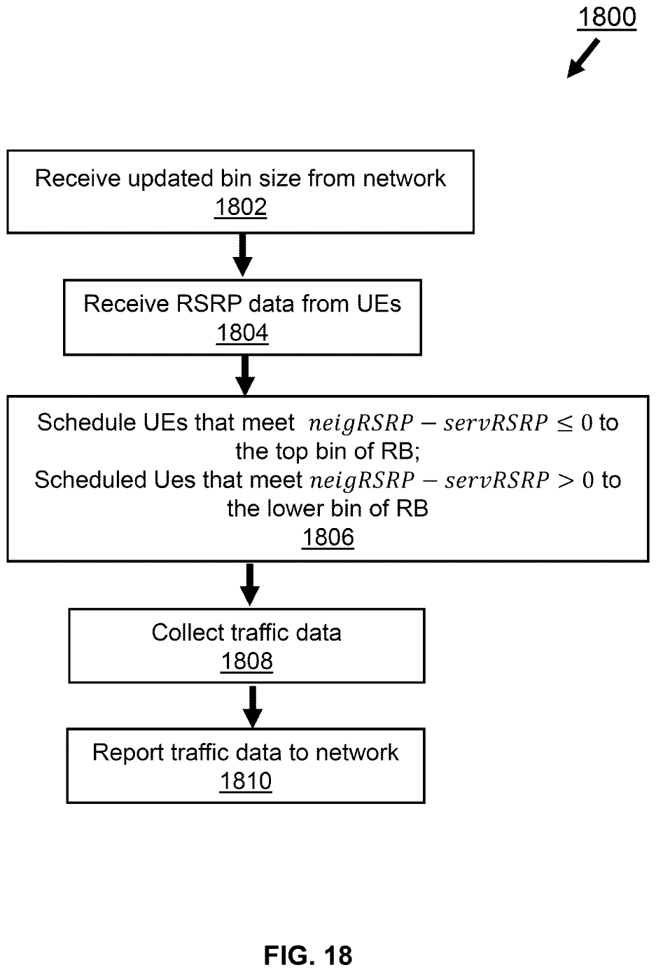

FIG. 18 illustrates some embodiments of a process for wireless communication by a BS for scheduling a UE to RBs. Referring to FIG. 18, process 1800 begins at processing block 1802 where processing logic receives updated bin size from the network (e.g., a RAN intelligent controller (RIC)). Process 1800 continues at processing block 1804 where processing logic receives RSRP data from UEs and then at processing block 1806 where processing logic schedules UEs meeting the condition: neigRSRP−servRSRP≤a predefined value (e.g., 0) to the top bin of the RBs and schedules UEs meeting the condition: neigRSRP−servRSRP>the predefined value (e.g., 0) to lower bin of the RBs. Process 1800 then continues at processing block 1808 where processing logic receives traffic data and at processing block 1810 processing logic reports the traffic data to the network.

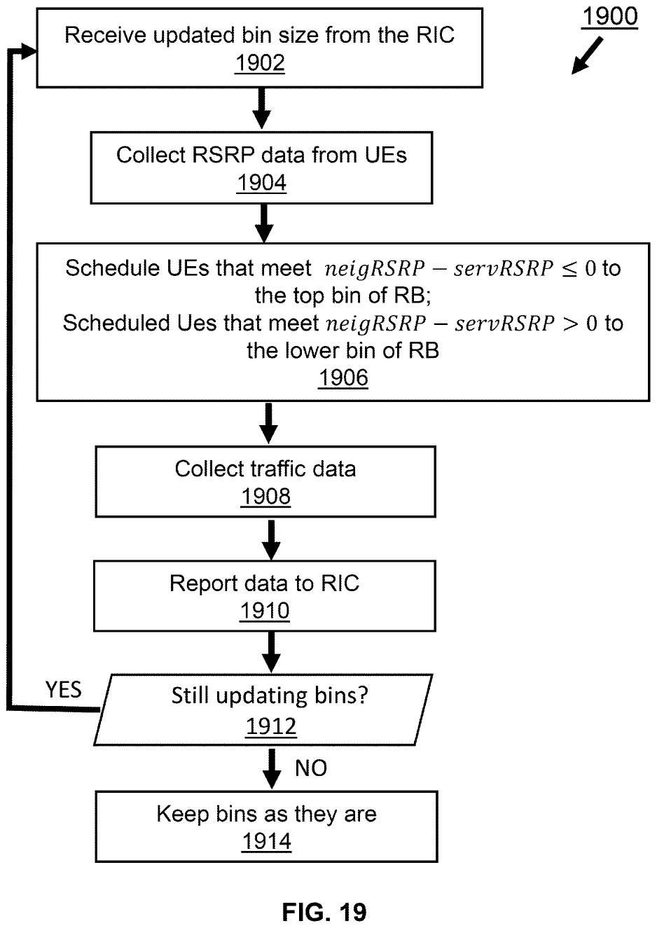

FIG. 19 illustrates some embodiments of a process for wireless communication by a BS for scheduling a UE to RBs. Referring to FIG. 19, process 1900 begins at processing block 1902 where processing logic receives updated bin size from the RIC. Process 1900 continues at processing block 1904 where processing logic receives RSRP data from UEs and then to processing block 1906 where processing logic schedules UEs meeting the condition: neigRSRP servRSRP≤a predefined value (e.g., 0) to the top bin of the RBs and schedule UEs meeting the condition: neigRSRP−servRSRP>the predefined value (e.g., 0) to lower bin of the RBs. Thereafter, at processing block 1908, processing logic receives traffic data and at processing block 1910 reports the traffic data to the network. Then, at processing block 1912, processing logic verifies whether the network is still updating bin assignment for the UEs. If the network is no longer updating bins, process 1900 transitions to processing block 1914 where processing logic maintains bins as they are. If the network is still updating bins, process 1900 transitions to processing block 1902 where processing logic receives an updated bin size from the RIC. Process 1900 may continue through the steps described herein.

Note that scheduling within a bin can follow any other arbitrary form of scheduling (e.g., pseudo-random, CQI-based, etc.). Collection of data can occur faster than how often data is reported to RIC. Thus, the process may be a loop as shown in FIG. 19, or collection of data may be faster and/or more frequent than reporting the data to RIC in the process.

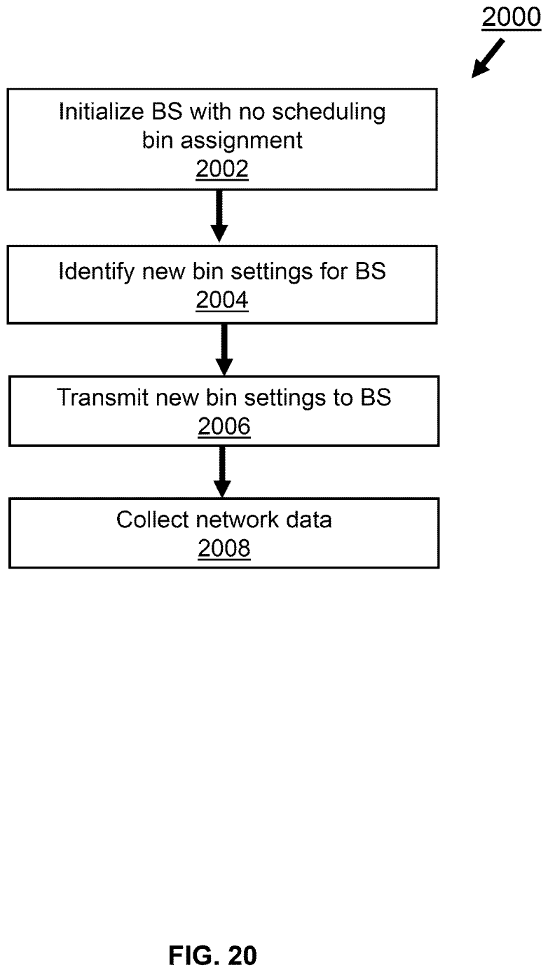

FIG. 20 illustrates some embodiments of a process for wireless communication by a network for scheduling a UE to RBs. Referring to FIG. 20, process 2000 begins at processing block 2002 where processing logic initializes a BS with no scheduling bin assignment. Process 2000 continues at processing block 2004 where processing logic identifies new bin settings for a BS and then at processing block 2006 transmits the new bin settings for the BS. Process 2000 continues at processing block 2008 where processing logic collects network data (e.g., traffic data and/or RSRP data).

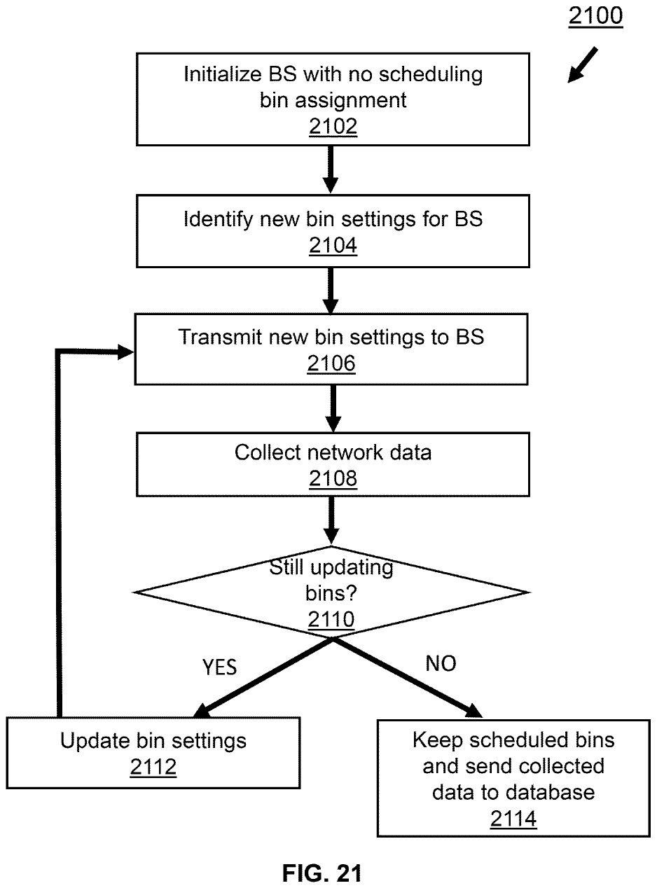

FIG. 21 illustrates some embodiments of a process for wireless communication by a network for scheduling a UE to RBs. Referring to FIG. 21, process 2100 begins at processing block 2102 where processing logic initializes a BS with no scheduling bin assignment. Process 2100 continues at processing block 2104 where processing logic identifies new bin settings for a BS and then at processing block 2106 transmits the new bin settings for the BS. Thereafter, process 2000 continues at processing block 2108 where processing logic collects network data (e.g., traffic data) and then at processing block 2110 processing logic verifies if the network is still updating bin assignment for the UEs. If the network is no longer updating bins, process 2100 transitions to processing block 2114 where processing logic maintains the scheduled bins and sends collected data to the database. If the network is still updating bin assignments, process 2100 transitions from processing block 2110 to processing block 2112 where processing logic updates bin settings. Then process 2100 continues at processing block 2106 where processing logic transmits new bin settings to the BS. Process 2100 may continue through the processing blocks described herein.

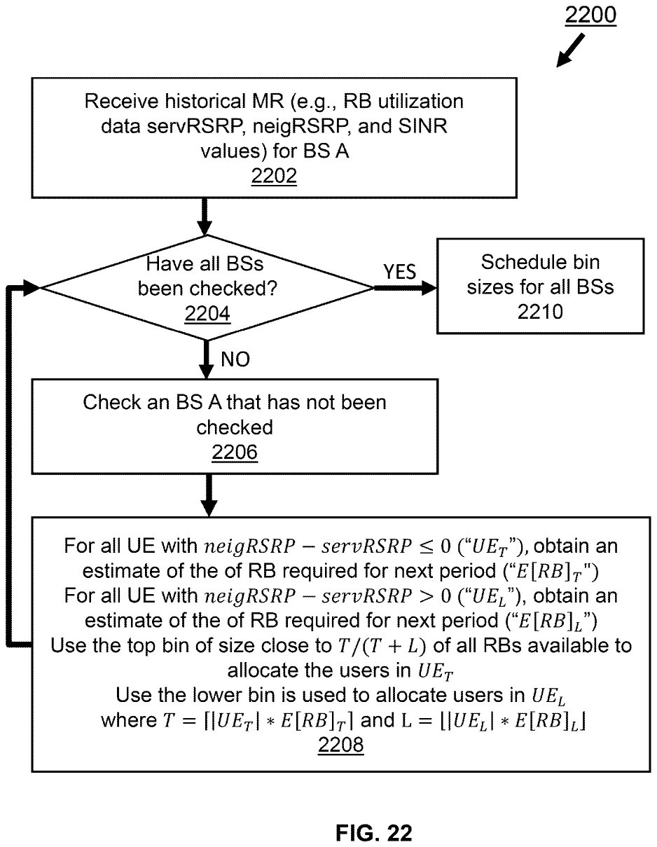

FIG. 22 illustrates some embodiments of a process for identifying new bin settings for a BS, for example described as processing block 2104 of FIG. 21. Referring to FIG. 22, process 2200 begins at processing block 2202 where processing logic receives historical measurement reports (MR) for BS A. In some embodiments, the MR includes RB utilization data servRSRP, neigRSRP, SINR values, or another key performance indicator (KPI) that depends on SINR (e.g., bitrate). Process 2200 continues at processing block 2204 where processing logic verifies whether all BSs have been checked. If all BSs haven't been checked, process 2200 transitions to processing block 2206 where processing logic checks BS A that has not been checked. Process 2200 continues to processing block 2208, where the processing logic of the RIC obtains an estimate of RBs required for next period (E[RB]_T) for UEs meeting the condition: neigRSRP-servRSRP≤0 (UE_Ts) and obtains an estimate of RBs required for next period (E[RB]_L) for UEs meeting the condition: neigRSRP-servRSRP>0 (UE_Ls). An estimate can be the last time period's data or a more complicated function/model. If all BSs have been checked at processing block 2204, process 2200 transitions to processing block 2210 where processing logic schedules bin sizes for all BSs.

In some embodiments, the RIC allocates UE_T using a top bin, wherein the top bin is a continuous block of RBs of size close to T/(T+L) of all RBs available, wherein T=┌|UE_T|*E[RB]_T┐, and L=└UE_L|*E[RB]_L┘, wherein |UE_T| comprises elements of UE_T and |UE_L| comprises elements of UE_L. “┌x┐” refers to a rounded up value of x, and “└x┘” refers to a rounded down value of x. For example, if x=1.5 then ┌x┐=2 and ┌x┐=1. The RIC allocates UE_L using a lower bin, wherein the lower bin is a block that is not the top bin.

Note that although embodiments discussed herein allocate UEs to top or lower bins, in alternative embodiments, such allocations can be reversed (e.g., to the lower or upper bins).

Although the techniques disclosed herein are shown for single antenna UEs and single antenna BS, they can also be applied with appropriate modifications in MIMO settings. One simple approach would convert the MIMO target SINR requirements to single antenna (SISO) scenario and directly apply the techniques specified here in that context as well. Another more attractive option directly considers the impact of multi-antenna array for reception at the base-station. In this case, in some embodiments, the multiple signals received across the array can be linearly combined into a single signal that has higher SINR than the signal at each individual antenna element. These are methods that are well known in the art. The disclosed techniques can be directly then applied at the output of the linear combiner.

Portions of what was described above may be implemented with logic circuitry such as a dedicated logic circuit or with a microcontroller or other form of processing core that executes program code instructions. Thus, processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present disclosure also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; et cetera.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

There are a number of example embodiments described herein.

Example 1 is a method of wireless communication by a user equipment (UE). The method includes associating with a first base station (BS); measuring reference signals received power (RSRP) data; reporting the RSRP data to the first BS; and transmitting on assigned resource blocks (RBs).

Example 2 is the method of example 1 that further includes receiving signals from the BS; measuring RSRP data to a neighbor BS (neigRSRP); and reporting RSRP data to the first BS (servRSRP).

Example 3 is the method of example 2, wherein the signals comprise one or more of data and control.

Example 4 is the method of example 1, further comprising associating with a new BS.

Example 5 is a user equipment (UE) comprising one or more processors configured to perform operations of the method of any one of Examples 1-5.

Example 6 is a non-transitory machine-readable medium having executable instructions to cause one or more processing units to perform the method of any one of Examples 1-5.

Example 7 is a UE baseband processor configured to cause a UE to perform the method of any one of Examples 1-5.

Example 8 is a method of wireless communication by a first base station (BS) for scheduling a user equipment (UE) into resource blocks (RBs). The method includes receiving updated bin size from a network; receiving reference signals received power (RSRP) data from user equipments (UEs); scheduling UEs meeting the condition: neigRSRP-servRSRP≤a predefined value (e.g., 0) to the top bin of resource blocks (RBs); scheduling UEs meeting the condition: neigRSRP−servRSRP>the predefined value to lower bin of RBs; collecting traffic data; and reporting the traffic data to the network. “neigRSRP” is a neighbor RSRP value to a neighbor BS from a UE. “servRSRP” is a serving RSRP value to the first BS from the UE.

Example 9 is a non-transitory machine-readable medium having executable instructions to cause one or more processing units to perform the method of Example 8.

Example 10 is a network comprising one or more processors configured to perform operations of the method of Example 8.

Example 11 is a method of wireless communication by a network for scheduling a user equipment (UE) into resource blocks (RBs). The method includes initializing a base station (BS) with no scheduling bin assignment; identifying new bin settings for the first BS; transmitting new bin settings to the first BS; and collecting network data.

Example 12 is the method of example 11 that further includes updating the bin settings; and transmitting updated bin settings to BSs.

Example 13 is the method of example 11 that further includes maintaining the bin settings; and reporting the network data to a database.

Example 14 is the method of any one of examples 11 to 13, wherein identifying new bin settings for a BS comprises: receiving a historical measurement reports (MR) for BS A; for UEs meeting the condition: neigRSRP-servRSRP≤a predefined value (e.g., 0) (UE_Ts), obtaining an estimate of RBs required for next period (E[RB]_T); for UEs meeting the condition: neigRSRP−servRSRP>the predefined value (UE_Ls), obtaining an estimate of RBs required for next period (E[RB]_L), wherein neigRSRP is a neighbor RSRP value to a neighbor BS from a UE, and servRSRP is a serving RSRP value to the first BS from the UE; allocating UE_T using a top bin, wherein the top bin is a continuous block of RBs of size close to T/(T+L) of all RBs available, wherein T=┌UE_T|*E[RB] . . . T┐, and L=└UE_L|*E[RB]_L┘, wherein |UE_T| comprises elements of UE_T and |UE_L| comprises elements of UE_L; and allocating UE_L using a lower bin, wherein the lower bin is a block that is not the top bin.

Example 15 is the method of example 14, wherein the MR comprises one or more of resource blocks (RBs) utilization data, servRSRP, neigRSRP, signal to interference plus noise ratio (SINR) values, or a key performance indicator (KPI) that depends on the SINR.

Example 16 is a non-transitory machine-readable medium having executable instructions to cause one or more processing units to perform a method of any one of Examples 11-15.

Example 17 is a network comprising one or more processors configured to perform operations of the method of any one of Examples 1-15.

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “selecting,” “determining,” “receiving,” “forming,” “grouping,” “aggregating,” “generating,” “removing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present disclosure is not described with reference to any particular programming language. It will be appreciated that a variety of programming languages may be used to implement the teachings of the disclosure as described herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing discussion merely describes some exemplary embodiments of the present disclosure. One skilled in the art will readily recognize from such discussion, the accompanying drawings and the claims that various modifications can be made without departing from the spirit and scope of the disclosure.

1. A method of wireless communication by a network for scheduling a user equipment (UE) into resource blocks (RBs), the method comprising:
initializing a first base station (BS) with no scheduling bin assignment;
identifying new bin settings for the first BS;
transmitting new bin settings to the first BS; and
collecting network data.

2. The method of claim 1, wherein the bin settings transmitted to the first BS configure allocation of RBs to UEs by the first BS.

3. The method of claim 1, further comprising:
updating the bin settings; and
transmitting updated bin settings to BSs.

4. The method of claim 1, further comprising:
maintaining the bin settings; and
reporting the network data to a database.

5. The method of claim 1, wherein identifying new bin settings for a BS is based on ranges of the relative RSRP difference between RSRPs of neighbor and serving cells.

6. The method of claim 5 wherein the bin settings are for two bins with two different ranges that each has an endpoint inclusive or exclusive of one predefined value.

7. The method of claim 1, wherein identifying new bin settings for the BS comprises:
receiving a historical measurement reports (MR) for BS A;
for UEs meeting the condition: the RSRP for the neighbor cell (neigRSRP)−the RSRP for the serving cell (servRSRP)≤a predefined value (UE_Ts), obtaining an estimate of RBs required for next period (E[RB]_T);
for UEs meeting the condition: neigRSRP−servRSRP>the predefined value (UE_Ls), obtaining an estimate of RBs required for next period (E[RB]_L), wherein neigRSRP is a neighbor RSRP value for signals to a neighbor BS from a UE, and servRSRP is a serving RSRP value for signals to the first BS from the UE;
allocating UE_T using a top bin, wherein the top bin is a continuous block of RBs of size close to T/(T+L) of all RBs available, wherein
T=┌|UE_T|*E[RB]_T┐, and
L=└|UE_L|*E[RB]_L┘, wherein |UE_T| comprises elements of UE_T and |UE_L| comprises elements of UE_L; and
allocating UE_L using a lower bin, wherein the lower bin is a block that is not the top bin.

8. The method of claim 7, wherein the MR comprises one or more of resource blocks (RBs) utilization data, servRSRP, neigRSRP, signal to interference plus noise ratio (SINR) values, and a key performance indicator (KPI) that depends on the SINR.

9. The method of claim 1, wherein the network data includes at least one of traffic data and RSRP data.

10. An apparatus comprising one or more processors configured to perform operations comprising:
initializing a first base station (BS) with no scheduling bin assignment;
identifying new bin settings for the first BS;
transmitting new bin settings to the first BS; and
collecting network data.

11. The apparatus of claim 10, wherein the bin settings transmitted to the first BS configure allocation of RBs to UEs by the first BS.

12. The apparatus of claim 11, wherein the operations further comprise:
updating the bin settings; and
transmitting updated bin settings to BSs.

13. The apparatus of claim 8, wherein the operations further comprise:
maintaining the bin settings; and
reporting the network data to a database.

14. The apparatus of claim 10, wherein identifying new bin settings for a BS is based on ranges of the relative RSRP difference between RSRPs of neighbor and serving cells.

15. The apparatus of claim 14 wherein the bin settings are for two bins with two different ranges that each has an endpoint inclusive or exclusive of one predefined value.

16. The apparatus of claim 10, wherein identifying new bin settings for a BS comprises:
receiving a historical measurement reports (MR) for BS A;
for UEs meeting the condition: the RSRP for the neighbor cell (neigRSRP)−the RSRP for the serving cell (servRSRP)≤a predefined value (UE_Ts), obtaining an estimate of RBs required for next period (E[RB]_T);
for UEs meeting the condition: neigRSRP−servRSRP>the predefined value (UE_Ls), obtaining an estimate of RBs required for next period (E[RB]_L), wherein neigRSRP is a neighbor RSRP value to a neighbor BS from a UE, and servRSRP is a serving RSRP value to the first BS from the UE;
allocating UE_T using a top bin, wherein the top bin is a continuous block of RBs of size close to T/(T+L) of all RBs available, wherein
T=┌UE_T|*E[RB]_T┐, and
L=┌UE_L|*E[[RB]_L], wherein |UE_T| comprises elements of UE_T and |UE_L| comprises elements of UE_L; and
allocating UE_L using a lower bin, wherein the lower bin is a block that is not the top bin.

17. The apparatus of claim 16, wherein the MR comprises one or more of resource blocks (RBs) utilization data, servRSRP, neigRSRP, signal to interference plus noise ratio (SINR) values, and a key performance indicator (KPI) that depends on the SINR.

18. The apparatus of claim 10, wherein the network data includes at least one of traffic data and RSRP data.

19. A method for scheduling across a wireless network using
binning of resource blocks (RBs) into a plurality of bins, wherein each bin of the plurality of bins specifies a range of radio strength conditions between a UE, its serving cell and its strongest neighbor cell;
identifying, for each UE, the bin to which the UE belongs; and
assigning, to said UE, RBs from the bin to which the UE belongs.

20. The method of claim 19 wherein bins are assigned and updated by RAN intelligent controllers in a coordinated way across the network.
